(19) United States
(12) Patent Application Publication
(10) Pub. No.: US 2008/0252028 A1
(43) Pub. Date: Oct. 16, 2008

(54) SHOCK ABSORBING DEVICE FOR TOY STROLLER

(76) Inventor: Ming-Tai Huang, Taipei (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/735,538

(22) Filed: Apr. 16, 2007

(51) Int. Cl. B62B 9/18

(52) U.S. Cl. 280/47.41

(57) ABSTRACT

A shock-absorbing device for a toy stroller includes a first member and a second member. An end of the first member is coupled with a lower end of one of a pair of cross-hinged beams of the toy stroller. The other end of the first member includes a base with an extension. An end of the second member is coupled with a wheel frame of the toy stroller. The other end of the second member has two spaced lateral walls and a top wall interconnected between the lateral walls, defining a compartment with a bottom opening for removably receiving the base and the extension. An inner face of a lateral wall of the other end of the second member includes a groove and a slot for respectively receiving a protrusion on the extension and an engaging block on the base.

### BACKGROUND OF THE INVENTION

The present invention relates to a shock-absorbing device and, more particularly to a shock-absorbing device for a toy stroller.

Shock-absorbing devices have been utilized in toy strollers for reducing shock during play and generally include exposed springs for performing the required shock-absorbing function. U.S. Pat. No. 6,059,302 discloses a shock-absorbing device for a toy stroller including a first member and a second member. An end of the first member is riveted to an upper frame of the toy stroller, and the other end of the first member includes a root section and a distal hooked end. The root section has a snapping fastener provided on each of two lateral faces thereof. An end of the second member is riveted to a lower frame of the toy stroller. The other end of the second member includes two lateral walls defining a channel therebetween through which the other end of the first member is extended. Each lateral wall of the second member includes an opening for engaging with an associated snapping fastener. The second member further includes a ridge for securely engaging with the distal hooked end of the first member. The shock-absorbing device of this type provides improved safety by eliminating exposed springs. However, detachment of the first member from the second member is difficult and requires tools, resulting in difficulties in dismantlement of the frame and the wheels and, hence, not allowing convenient storage and transport.

It is therefore a need in a toy stroller that allows easy disassembly while providing shock-absorbing function.

### BRIEF SUMMARY OF THE INVENTION

A shock-absorbing device in accordance with the present invention includes a first member and a second member. The first member has a first end adapted to be coupled with a lower end of one of a pair of cross-hinged beams whose upper end is coupled with a body of the toy stroller. The first member further includes a second end having a base and an extension extending upward from the base. The base includes an engaging block on a lateral side thereof. The extension includes a protrusion extending outward from a lateral side thereof. The second member includes a first end adapted to be coupled with a wheel frame of the toy stroller. The second member further includes a second end having two spaced lateral walls and a top wall interconnected between the lateral walls, defining a compartment with a bottom opening. Each lateral wall of the second end of the second member includes an inner face having an inner portion adjacent to the first end of the second member and an outer portion distant to the first end of the second member. One of the inner faces of the lateral walls of the second member includes a groove in the inner portion thereof and a slot in the outer portion thereof. The groove includes an open, lower end aligned and in communication with the bottom opening of the compartment. The base and the extension of the first member is removably received in the compartment of the second member via the bottom opening. The protrusion of the first member is removably received in the groove of the second member via the open, lower end of the groove. The engaging block of the first member is engaged in the slot of the second member.

Preferably, the groove of the second member includes a closed, upper end distant to the first end of the second member than the open, lower end of the groove.

Preferably, the second member further includes a stop extending from the inner faces of the lateral walls between the groove and the slot, defining a subcompartment in the compartment of the second member. The extension of the first member extension of the first member is hook-shaped and removably received in the subcompartment. The extension of the first member is engaged with and stopped by the stop when the first member is pulled away from the second member in a direction perpendicular to an extending direction of the groove.

Preferably, the engaging block of the first member includes a first inclined face and a second inclined face. The first inclined face extends downward from an upper portion of one of lateral sides of the base and at an acute angle with the lateral side of the base. The second inclined face extends upward from a lower portion of the lateral side of the base and at an acute angle with the lateral side of the base.

Preferably, the acute angle between the first inclined face and the lateral side of the base is in a range between 10 and 20 degrees, and the acute angle between the second inclined face and the lateral side of the base is in a range between 20 and 40 degrees.

Other objectives, advantages, and novel features of the invention will become more apparent from the following detailed description when taken in conjunction with the accompanying drawings.

### DESCRIPTION OF THE DRAWINGS

FIG. 1 shows a diagrammatic side view of a toy stroller according to the preferred teachings of the present invention.

FIG. 2 shows a partial, perspective view of a portion of the toy stroller of FIG. 1, illustrating shock-absorbing devices of the toy stroller.

FIG. 3 shows an exploded perspective view, partly cutaway, of the shock-absorbing device of FIG. 2.

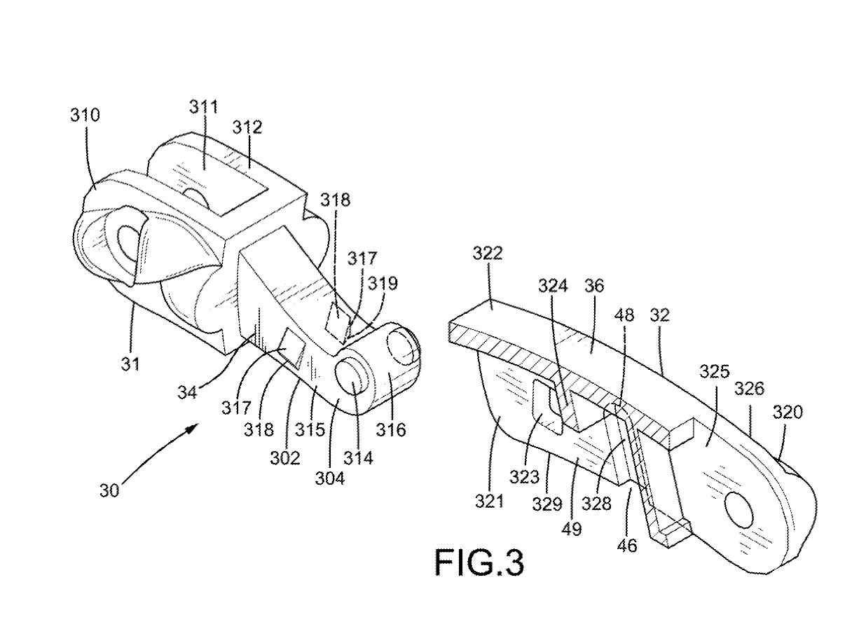

FIG. 4 shows a partly-sectioned side view of the shock-absorbing device of FIG. 3 in an assembled position.

FIG. 5 is a view similar to FIG. 4, showing dismantlement of the shock-absorbing device of FIG. 4.

### DETAILED DESCRIPTION OF THE INVENTION

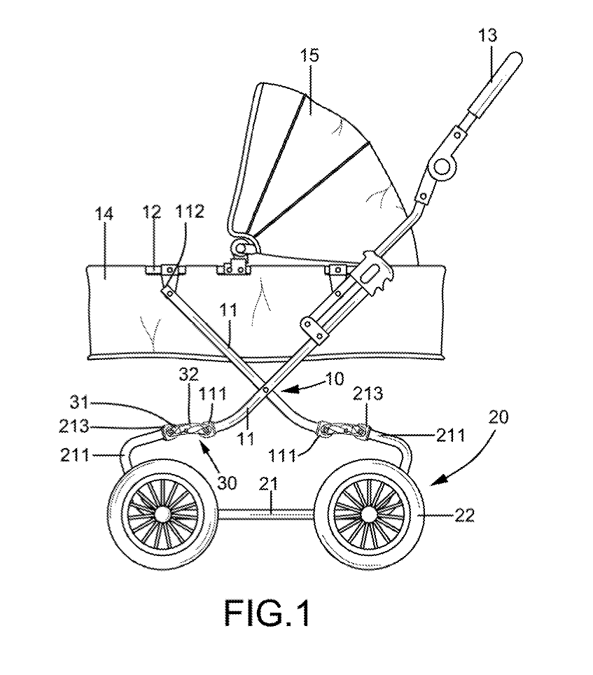

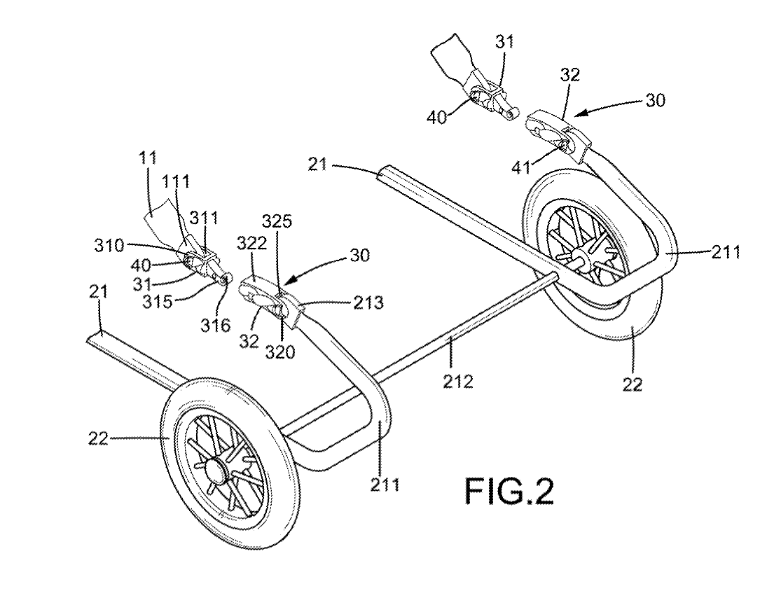

FIGS. 1 and 2 illustrate a toy stroller according to the preferred teachings of the present invention. The toy stroller includes a body 10 and a wheel frame 20. A pair of cross-hinged beams 11 is attached to each of two lateral sides of the toy stroller. Each beam 11 includes an upper end 112 connected to a bed frame 12 to which a bed 14 is mounted. A canopy 15 is mounted on top of the bed 14. The toy stroller further includes a substantially U-shaped foldable handle 13. The wheel frame 20 includes front and rear axles 212 to which front and rear wheels 22 are mounted. Two support rods 21 extend between the front and rear axles 212. A substantially U-shaped extension 211 extends upward from each of two ends of each support rod 21 and includes an upper end 213.

According to the preferred form, a plurality of shock-absorbing devices 30 are mounted between the body 10 and the wheel frame 20 for providing a shock-absorbing function. Each shock-absorbing device 30 includes a first member 31 and a second member 32. The first member 31 includes a first end 310 coupled with a lower end 111 of one of the beams 11. The first end 310 of the first member 31 includes two spaced lugs 312 defining a space 311 for pivotably receiving the lower end 111 of an associated beam 11 with the use of a pivot pin 40. The first member 31 further includes a second end 34 having a base 315 and a substantially hook-shaped extension 316 extending upward from the base 315. A protrusion 314 projects outward from each of two lateral sides 304 of the extension 316 and is perpendicular to the lateral sides 304. An engaging block 318 is formed on each of two lateral sides 302 of the base 315. In the preferred form shown, the engaging block 318 is wedge-shaped and includes a first inclined face 317 and a second inclined face 319. The first inclined face 317 extends downward from an upper portion of an associated lateral side 301 of the base 315 and at an acute angle with the associated lateral side 302 of the base 315. The second inclined face 319 extends upward from a lower portion of an associated lateral side 302 of the base 315 and at an acute angle with the associated lateral side 302 of the base 315. The first inclined face 317 and the second inclined face 319 join with each other at their distal edges thereof. The acute angle between the first inclined face 317 and the lateral side 302 of the base 315 is preferably in a range between 10 and 20 degrees and the acute angle between the second inclined face 319 and the lateral side 302 of the base 315 is preferably in a range between 20 and 40 degrees.

According to the preferred form, the second member 32 includes a first end 320 coupled with the upper end 213 of the extension 211 of one of the support rods 21. The first end 320 of the second member 32 includes two spaced lugs 326 defining a space 325 therebetween for pivotably receiving the upper end 213 of an associated support rod 21 with the use of a pin 41. The second member 32 further includes a second end 36 having two spaced lateral walls 329 and a top wall 322 interconnected between upper edges of the lateral walls 329, defining a compartment 321 with a bottom opening 38. The second end 34 of the first member 31 can be inserted into the compartment 321 via the bottom opening 38 of the second member 32. Each lateral wall 329 of the second member 32 further includes an inner face 49 with a groove 328 in an inner portion thereof adjacent to the first end 320 of the second member 32. The groove 328 includes an open, lower end 46 aligned with the bottom opening 38 and a closed, upper end 48 adjacent to the top wall 322. The closed, upper end 48 of the groove 328 is distant to the first end 320 of the second member 32 than the open, lower end 46 of the groove 328 to assist in coupling between the first and second members 31 and 32. The compartment 321 has a width slightly greater than that of the extension 316 of the first member 31 whereas each groove 328 has a width slightly greater than a diameter of the associated protrusion 314. Each lateral wall 329 of the second member 32 further includes a slot 323 in an outer portion thereof distant to the first end 320 of the second member 32. Further, the second member 32 includes a stop 324 extending from the inner face 49 between the groove 328 and the slot 323 and perpendicular to the lateral walls 329. The stop 324 defines a subcompartment 44 in the compartment 321 for receiving the extension 316 of the first member 31.

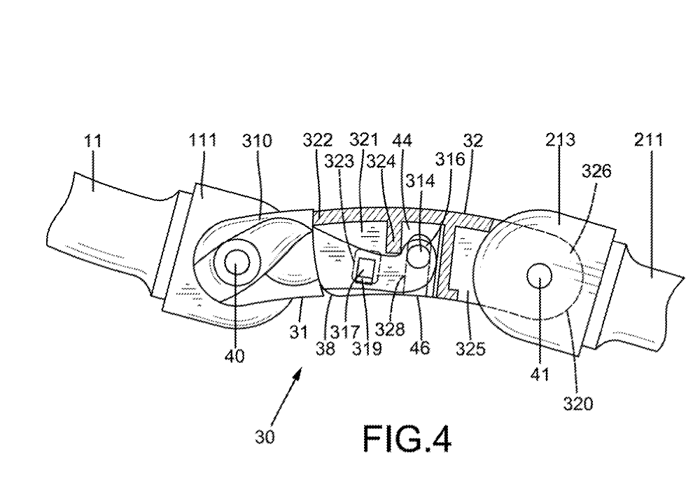

In assembly, the extension 316 of the first member 31 is inserted into the subcompartment 44 of the second end 36 of the second member 32 via the bottom opening 38 of the second member 32. The protrusions 314 of the first member 31 are firstly slid into the respective grooves 328 of the second member 32 until the engaging blocks 318 of the first member 31 are stopped by the lateral walls 329 of the second member 32. Then, a force is applied to the second end 34 of the first member 31 and, thus, forcibly inserts the engaging blocks 318 of the first member 31 into the respective slots 323 of the second member 32. In the assembled position shown in FIG. 4, the extension 316 of the first member 31 is engaged with and stopped by the stop 324 when the first member 31 is pulled away from the second member 32 in a direction perpendicular to an extending direction of the groove 328. Thus, undesired disengagement of the second member 32 from the first member 31 is avoided. Furthermore, the engaging blocks 318 of the first member 31 are securely engaged in the respective slots 323 of the second member 32. The first inclined face 317 of each engaging block 318 assists in sliding motion of the engaging block 318 of the first member 31 into the associated slot 323 of the second member 32.

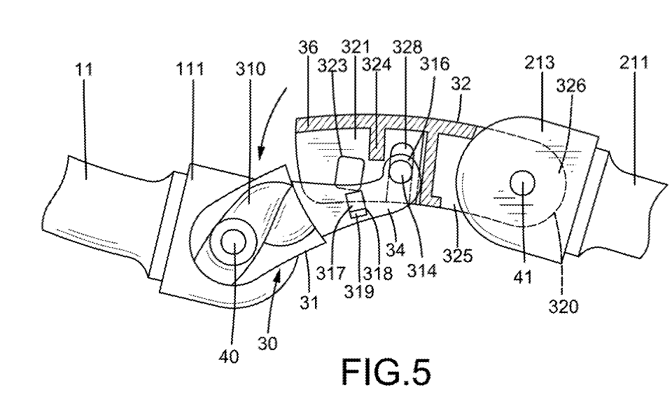

In a case that dismantlement of the first and second members 31 and 32 is required, a user applies a downward force to the first member 31 (see the arrow in FIG. 5) to disengage the second end 34 of the first member 31 from the second end 36 of the second member 32. The downward force can be small but sufficient to disengage the engaging blocks 318 from the respective slots 323 of the second member 32 due to provision of the second inclined face 319 on each engaging block 318. Subsequent disengagement of the extension 316 of the first member 31 from the subcompartment 44 of the second member 32 can be achieved without effort. Thus, dismantlement of the first and second members 31 and 32 can be easily achieved to disassemble the body 10 and the wheel frame 20 without any tools, which is convenient to the user when storage or transport of the toy stroller is required.

It can be appreciated that the first member 31 may include only one engaging block 318 and only one protrusion 314 whereas the second member 31 may include only one slot 323 and only one groove 328.

Although specific embodiments have been illustrated and described, numerous modifications and variations are still possible without departing from the teachings of the invention. The scope of the invention is limited by the accompanying claims.

1. A shock-absorbing device for a toy stroller, comprising:
a first member including a first end adapted to be coupled with a lower end of one of a pair of cross-hinged beams whose upper end is coupled with a body of the toy stroller, with the first member further including a second end having a base and an extension extending upward from the base, with the base including an engaging block on a lateral side thereof, and with the extension including a protrusion extending outward from a lateral side thereof; and
a second member including a first end adapted to be coupled with a wheel frame of the toy stroller, with the second member further including a second end having two spaced lateral walls and a top wall interconnected between the lateral walls, defining a compartment with a bottom opening, with each of the lateral walls of the second end of the second member including an inner face having an inner portion adjacent to the first end of the second member and an outer portion distant to the first end of the second member, with one of the inner faces of the lateral walls of the second member including a groove in the inner portion thereof and a slot in the outer portion thereof, with the groove including an open, lower end aligned and in communication with the bottom opening of the compartment, with the base and the extension of the first member being removably received in the compartment of the second member via the bottom opening, with the protrusion of the first member being removably received in the groove of the second member via the open, lower end of the groove, with the engaging block of the first member being engaged in the slot of the second member.

2. The shock-absorbing device for a toy stroller as claimed in claim 1, with the groove of the second member including a closed, upper end distant to the first end of the second member than the open, lower end of the groove.

3. The shock-absorbing device for a toy stroller as claimed in claim 1, with the extension of the first member being hook-shaped, with the second member further including a stop extending from the inner faces of the lateral walls between the groove and the slot, defining a subcompartment in the compartment of the second member, with the extension of the first member being removably received in the subcompartment, and with the extension of the first member being engaged with and stopped by the stop when the first member is pulled away from the second member in a direction perpendicular to an extending direction of the groove.

4. The shock-absorbing device for a toy stroller as claimed in claim 1, with the engaging block of the first member including a first inclined face and a second inclined face, with the first inclined face extending downward from an upper portion of one of the lateral sides of the base and at an acute angle with the lateral side of the base, with the second inclined face extending upward from a lower portion of the lateral side of the base and at an acute angle with the lateral side of the base.

5. The shock-absorbing device for a toy stroller as claimed in claim 4, with the acute angle between the first inclined face and the lateral side of the base being in a range between 10 and 20 degrees, and with the acute angle between the second inclined face and the lateral side of the base being in a range between 20 and 40 degrees.
